(19) United States
(12) Patent Application Publication
(10) Pub. No.: US 2009/0249604 A1
(43) Pub. Date: Oct. 8, 2009

(54) METHOD AND APPARATUS FOR RELEASING SUPPORT PLATE AND WAFER CHIPS FROM EACH OTHER

(75) Inventor: Akihiko Nakamura, Kanagawa (JP)

Correspondence Address: SCHWEGMAN, LUNDBERG & WOESSNER, P.A., P.O. BOX 2938, MINNEAPOLIS, MN, 55402, US

(73) Assignee: Tokyo Ohka Kogyo Co., Ltd., Kanagawa (JP)

(21) Appl. No.: 12/309,846

(22) PCT Filed: Jul. 5, 2007
(86) PCT No.: PCT/JP2007/000736

§ 371 Date: Jan. 30, 2009

(30) Foreign Application Priority Data
Aug. 8, 2006 (JP) 2006-215504

(51) Int. Cl. B23P 19/02; B23P 19/00

(52) U.S. Cl. 29/426.4; 29/762

(57) ABSTRACT

The present invention provides an apparatus for releasing a support plate and wafer chips from each other. A wafer 5 supported on a support plate using an adhesive 3 has been divided into a plurality of wafer chips so that wafer grooves 23 are formed. In a receiving part that is defined by a peripheral wall 18 in a porous plate 10 and that is for receiving porous portions 17, the wafer chips 5 and a support plate 1 are suctioned and held via the suction by suction pipes 12 in the porous plate 10 via suction ports 15, grooves 21, communicating cutouts 22, and the porous portions 17. A release agent supplied from the external environment is guided to the wafer grooves 23 formed between a plurality of wafer chips 5′ in order to contact and dissolve the adhesive agent 3.

### TECHNICAL FIELD

The present invention relates to a method and an apparatus by which a support plate and a plurality of wafer chips that are obtained by dividing a wafer and that are supported on the support plate using an adhesive agent can be easily released from each other.

### BACKGROUND ART

Portable electronic devices such as IC cards, mobile phones, digital cameras, etc. are widely used. In recent years, there has been demand for all of these devices to become thinner, smaller, and lighter.

In order to meet this demand, semiconductor chips used in these devices must also become thinner.

It has been said that the thickness of silicon wafers (simply referred to as a wafer or wafer chips hereinafter) used to produce semiconductor chips must be reduced to between 25 μm and 50 μm for the next-generation semiconductor chips, while the current wafer thickness is between 125 μm and 150 μm.

The conventional methods of thinning wafers have consisted of, for example, applying protective tape on the circuit formation surface of a wafer, inverting the wafer and grinding the bottom surface of the wafer with a grinder in order to thin it, polishing the bottom surface of the wafer, seating the bottom surface of the wafer on dicing tape held by a dicing frame, peeling the protective tape from the circuit formation surface of the wafer, and dicing the wafer into chips using a dicing device.

However, in this method, cracks are often made in a wafer when protective tape is peeled from the wafer. Further, a thinned wafer cannot be supported only on protective tape. Manual labor is required for transportation of such a wafer. Accordingly, this process cannot be automated.

In order to cope with this situation, a protective substrate obtained by impregnating ladder type silicon oligomer to a stomatal sintered body of aluminum nitride-boron nitride is sometimes used instead of protective tape in order to hold wafers. In other cases, a protective substrate (support plate) consisting of alumina, alumina nitride, boron nitride, silicon carbide, or the like, which have a thermal expansion rate substantially the same as that of wafers, is used to hold the wafers.

In such cases, a wafer and a protective substrate have to be bonded together. For an adhesive material in the bonding, a film with a thickness between 10 μm and 100 mμ made of thermoplastic resin such as polyimide is used in some cases, and a film (obtained by spin-coating adhesive resin solution and drying it) with a thickness equal to or smaller than 20 mμ is used in other cases.

After thinning a wafer that has been bonded to a protective substrate, the ground/polished surface has to be seated on dicing tape, and the adhesive agent used for bonding the wafer and the protective substrate has to be melted or dissolved in order to release the wafer and the protective substrate from each other.

A method in which a release agent, in order to dissolve the adhesive agent, is made to penetrate from the periphery of the wafer and the protective substrate that are combined using the adhesive agent takes too long a time, which is problematic.

In order to overcome this problem, Patent Document 1 proposes a method in which a wafer is attached by using an adhesive agent to a support plate that is a rigid body with a number of through holes whose diameter is approximately 400 μm.

This method is advantageous in that an adhesive agent can be used highly efficiently because there are a number of through holes in the support plate and in that wafers are easy to handle even after being ground/polished into an extremely thin state because the support plate is a rigid body such as glass or the like.

This method is advantageous also in that a release agent can easily penetrate an adhesive agent via the through holes provided to the support plate so that the time required to dissolve the adhesive agent can be reduced.

However, the above method is problematic in that providing a number of through holes with a diameter of approximately 400 μm to a support plate that is as rigid as a wafer is very troublesome, making the support plate very expensive.

### Patent Document 1:

### Japanese Patent Application Publication No. 2005-191550 (Abstract and FIG. 3)

### DISCLOSURE OF THE INVENTION

In view of the above problems, it is an object of the present invention to provide a method and apparatus by which a support plate having no holes is used, and in which the support plate and a plurality of wafer chips that are obtained by dividing a wafer supported on the support plate using an adhesive agent can be easily released from each other by guiding a release agent to the adhesive agent through a porous plate.

A method of releasing a support plate and wafer chips from each other according to the present invention includes steps of dividing a wafer supported on a support plate using an adhesive agent into a plurality of wafer chips so that a groove is formed; holding wafer chips via suction by a porous plate; and guiding a release agent to the groove.

Also, the method of releasing a support plate and wafer chips from each other according to the present invention includes steps of dividing a wafer supported on a support plate using an adhesive agent into a plurality of wafer chips so that a groove is formed; holding wafer chips via suction by a porous plate; immersing the wafer chips in a release agent; and guiding the release agent to the groove via the suction.

In the above method of releasing a support plate and wafer chips from each other, it is desirable that the release agent and the adhesive agent be made to contact each other and that the adhesive agent be melted when the release agent is guided.

In the above case, it is also possible to employ a configuration in which a wafer is divided for each device. It is also possible to employ a configuration in which the suction is performed at a center of the porous plate.

It is also possible to employ a configuration in which a plurality of areas are formed with boundaries forming concentric circles around a center in the porous plate, and the suction is performed for each area.

In the above case, it is also possible to employ a configuration in which the suction is started at different time points sequentially from a central area toward peripheral areas. It is also possible to employ a configuration in which the suction is performed in such a manner that suctioning power is decreased with increasing distance from a central area toward peripheral areas.

An apparatus for releasing a support plate and wafer chips from each other according to the present invention includes a porous plate for suctioning and holding singulated wafer chips supported on the support plate using an adhesive agent, and for suctioning a release agent.

It is possible to employ a configuration in which a plurality of areas are formed with boundaries forming concentric circles about a central portion in the porous plate, and suction is performed from a central area sequentially to peripheral areas by a suction line connected to the central portion. It is also possible to employ a configuration in which a plurality of areas are formed with boundaries forming concentric circles about a central portion in the porous plate, and suction is performed by suction lines that are individual for each area.

In the above case, it is also possible to employ a configuration in which partitions are provided to the boundaries between the areas.

Thereby, the present invention can provide a method and an apparatus by which a support plate and a plurality of wafer chips that are obtained by dividing a wafer and that are supported on the support plate using an adhesive agent can be easily released from each other.

### BRIEF DESCRIPTION OF THE DRAWINGS

FIG. 1 schematically shows steps of bonding a wafer and a support plate and of thinning the wafer, both of which are performed as an embodiment 1;

FIG. 2 shows a releasing process that is unique to the present embodiment 1;

FIG. 3A is a top view explaining the releasing process;

FIG. 3B is a perspective view showing the cross section along line A-A′ in FIG. 3A; and

FIG. 3C is a perspective view showing a part of the supporting surface of a porous plate in an enlarged manner.

### NUMERALS

1: support plate
2: through hole
3: adhesive agent layer
5: wafer
5′: wafer chip
6: shaft
7: grinder
8: metal thin film
9: bottom-surface circuit
10: porous plate
11: suctioning apparatus
12: suction pipe
13: handle jig
14: concentric circular area (14-1 through 14-3)
15: suction port
16: on-off valve (16-1 through 16-3)
17: porous portion
18: peripheral wall
19: convex portion
22: communicating cutout
23: wafer groove

### BEST MODES FOR CARRYING OUT THE INVENTION

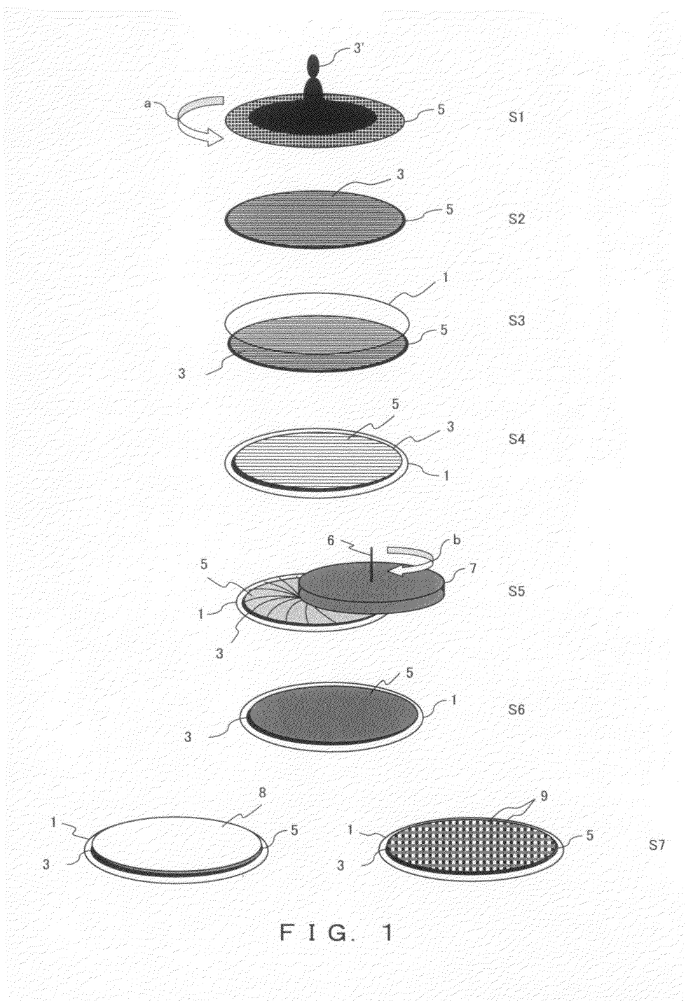

FIG. 1 schematically shows steps of adhering a wafer to a support plate and of thinning the wafer, both of which are performed as an embodiment 1. In step S1, a wafer set on the processing stand of a spin cup is spun in the direction of arrow a.

Thereafter, a liquid adhesive agent 3′ is dropped onto a surface of the wafer 5 on which circuits have been formed so that the surface is spin coated. Thereby, the entire upper surface (circuit formation surface) of the wafer 5 is evenly coated with the liquid adhesive agent 3′.

As a method of coating an adhesive agent, other methods can be used such as a method in which an applicator is used to apply an adhesive agent in a manner similar to that of rolling out dough by using a rolling pin or a method in which a slit nozzle having a width of at least that of the diameter of the wafer 5 is used to apply an adhesive agent.

As the adhesive agent, water-insoluble high polymer compounds are used because water will be used for polishing the wafer 5.

An adhesive agent with a high softening temperature (such as one made from acrylic materials) is used because processes carried out at high temperatures such as a process of attaching a DAF (die attach film) will be conducted. This process of attaching a DAF will be explained later.

In step S2, the wafer 5 to which the liquid adhesive agent 3′ has been applied is removed from the spin cup, and is moved to a bake plate. The bake plate is equipped with an oven.

In the bake plate, the above liquid adhesive agent 3′ is dried and its fluidity is reduced. The hard adhesive agent layer 3 is kept in a layered state. In this drying process, the liquid adhesive agent 3′ is heated for a prescribed time period at a temperature, for example, between 40° C. and 200° C.

In step S3, the wafer 5 and a support plate 1 are aligned by using an alignment device.

In step S4, the wafer 5 and the support plate 1 aligned in the above manner are bonded together by the thermal compression bonding method with the adhesive agent layer 3 between them. For this thermal compression bonding, the bake plate is used again.

The bake plate is equipped with a decompression device in addition to the oven. The above thermal compression bonding is performed in the decompression chamber in the bake plate at a temperature ranging, for example, from 40° C. through 300° C. This thermal compression bonding causes the wafer 5 and the support plate 1 to be in a temporary combined state.

As described above, a rigid material such as glass, etc. is used for the support plate 1, and accordingly the combined body consisting of the wafer 5 and the support plate 1 is easy to handle. Thereafter, the combined body consisting of the support plate 1 and the wafer 5 is inverted and is subjected to natural cooling.

In step s5, an anti-transfer sheet (not shown) is applied on the bottom surface of the support plate 1 (the surface opposite to the wafer-supporting surface) in the combined body that has been cooled.

Thereafter, the combined body that has been cooled is brought to a grinding apparatus (not shown), and is fixed to the processing stand with the support plate 1 vacuumed to the stand.

Thereafter, a grinder 7 held at the tip of a shaft 6 of the grinding apparatus spins in the direction of arrow b in order to grind the bottom surface (non-bonded surface) of the wafer 5 to a prescribed thickness.

In step S6, the bottom surface (non-bonded surface) of the wafer 5 that has been ground by the grinder 7 is polished to a mirror-smooth state.

The execution of the subsequent step, S7, is not an essential step. In step S7, a back metallization process in which a metal thin film 8 is formed on the mirror-finished bottom surface of the wafer 5 or a process in which a bottom-surface circuit 9 is formed on the mirror-finished bottom surface of the wafer 5 is performed. In some cases, one of these processes is selected to be executed, and in other cases, none of them is executed.

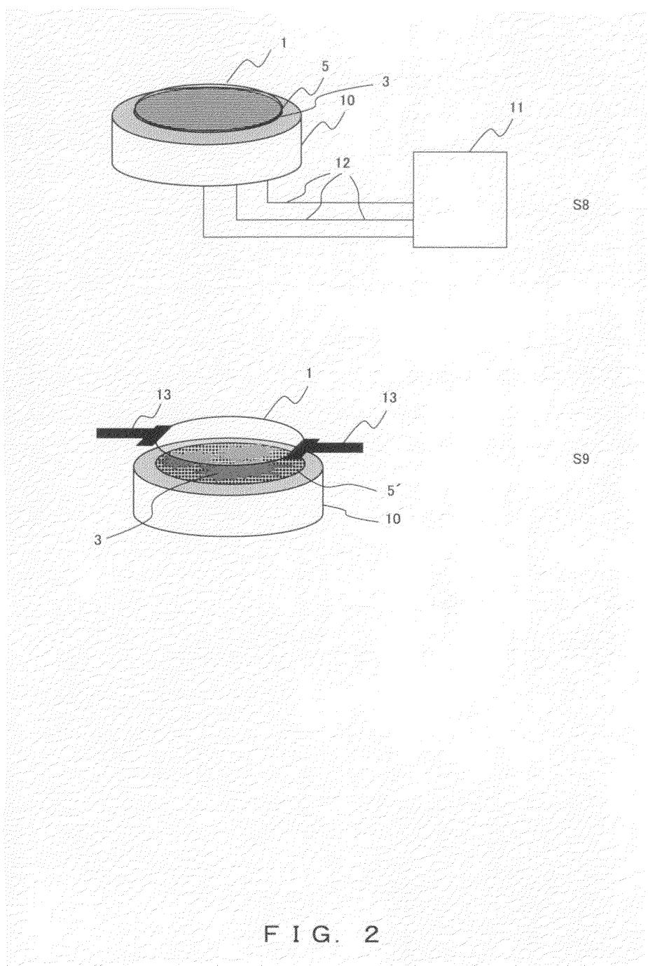

FIG. 2 shows a releasing process following the above steps. This process is unique to the present invention. In the present example, it is assumed that the wafer 5 is divided into a plurality of wafer chips so that grooves are formed between the wafer chips before the execution of the releasing process.

In the above dividing of the wafer 5, the wafer 5 may be divided into devices or may be divided into areas consisting of a plurality of devices.

In step S8 in FIG. 2, the combined body of the support plate 1 and the wafer 5 (consisting of the wafer chips) is inverted (so that the support plate 1 becomes the top and the wafer 5 becomes the bottom), and is supported on a porous plate 10.

A suctioning apparatus 11 is connected to the porous plate 10 via suction pipes 12. The porous plate 10 and the suctioning apparatus 11 constitute an apparatus for releasing a support plate and a wafer from each other.

In this configuration, a release agent is provided to the supporting portion of the porous plate 10, and the adhesive agent 3 is dissolved by being penetrated by the release agent or being immersed in the release agent. Thereafter, the adhesive agent 3 is suctioned by the suctioning apparatus 11. This process will be explained later in detail.

In step S9, handle jigs 13 are used to remove the support plate 1 from the wafer 5.

In this method, the process does not wait until the adhesive agent 3 is dissolved completely, but the support plate 1 is removed from the wafer 5 when the adhesive agent 3 has been dissolved enough to allow the removal, and this results in an increase in throughput.

In a subsequent process (not shown), the adhesive agent 3 remaining on the surface of the wafer 5 is removed by using a cleaning fluid, the surface is dried, and the singulated wafer chips are contained in an appropriate container.

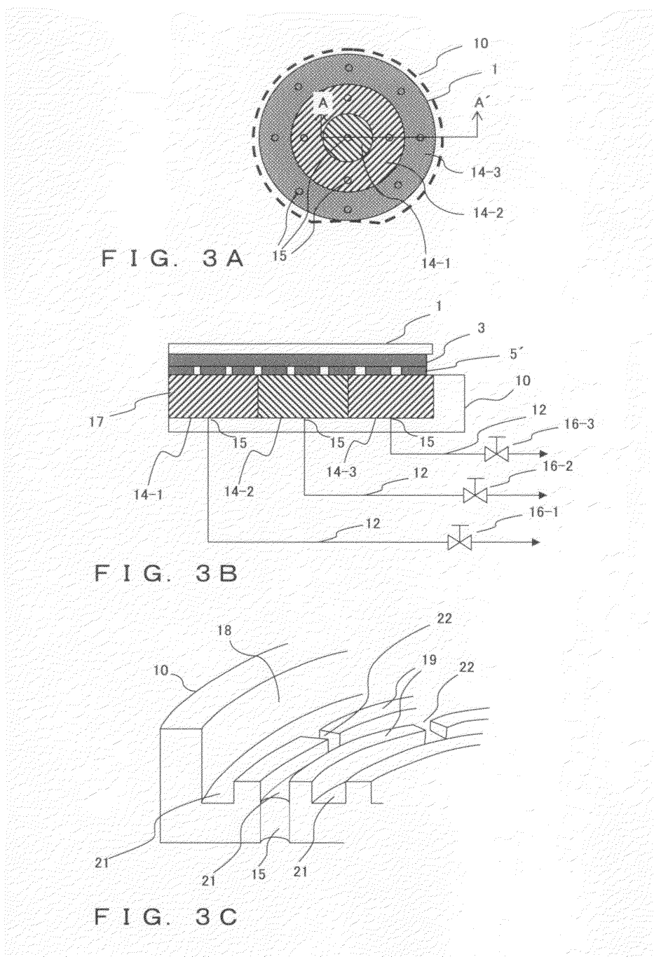

FIG. 3A is a top view explaining the above step S8. FIG. 3B is a cutaway perspective view showing the cross section along line A-A′ in FIG. 3A. FIG. 3C is a perspective view showing a part of the supporting surface of the porous plate 10 in an enlarged manner.

As shown in FIGS. 3A and 3B, a plurality (three in this embodiment) of areas 14 (14-1 through 14-3) are formed in the porous plate 10 in such a manner that the boundaries form concentric circles around the center.

Each of the areas 14 has a plurality of suction ports 15 (the central area has only one suction port in this example). The suction pipes 12 of the suctioning apparatus 11 shown in FIG. 2 are respectively connected to the suction ports 15 as shown in FIG. 3B.

The suction pipes 12 are equipped with on-off valves 16 (16-1 through 16-3).

With these on-off valves 16 being opened and closed arbitrarily, the effect of the suction can be made to propagate sequentially from area 14-1 to the surrounding areas 14-2 and 14-3 by using only a single suction pipe 12 (for example the suction pipe 12 that is equipped with the on-off valve 16-1 and is connected to the central area).

As a matter of course, the suction may be performed by each of the suction pipes 12 that are unique to each of the areas 14-1 through 14-3.

In such a case, the suction processes may be started sequentially at different time points (for example, starting from the central area 14-1 to the surrounding areas 14-2 and 14-3), and also the suctioning power can be set to decrease with increasing distance from the central area 14-1 toward the periphery (areas 14-2 and 14-3).

In addition, in such a case, partitions are desirably provided to the boundaries (the above concentric circles) between the respective areas 14.

As shown in FIG. 3C, the supporting portion of the porous plate 10 for receiving porous portions 17 shown in FIG. 3B is defined by a peripheral wall 18.

A plurality of convex portions 19 are formed on the bottom of the receiver portion in such a manner that the convex portions form concentric circles. Grooves 21 are formed between the peripheral wall 18 and the outermost convex portion 19 and between the other convex portions 19.

Also, communicating cutouts 22 are formed between the adjacent grooves 21 by partially cutting away the convex portions 19. The above described suction ports 15 are formed in the grooves 21.

In this configuration, wafer chips 5′ supported on the support plate 1 using the adhesive agent 3 are suctioned and held by the porous plate 10 as shown in FIG. 3B.

Using any of the suction pipes 12, the wafer chips 5′ can be suctioned and held evenly via the suction ports 15, the grooves 21, the communicating cutouts 22, and the porous portions 17.

Also, a release agent is supplied from the external environment to the porous portion receiving part (combined body supporting portion) surrounded by the peripheral wall 18 in the porous plate 10, and this is not shown in a drawing. The release agent is used for melting the adhesive agent 3 from its peripheral portion.

This release agent is guided, by the suction via the suction ports 15, the grooves 21, the communicating cutouts 22, and the porous portions 17 for suctioning and holding the wafer chips 5′, to wafer grooves 23 between the wafer chips 5′.

The release agent guided to the wafer grooves 23 contacts the adhesive agent 3 to start dissolving the adhesive agent 3 starting from the portion in contact with the release agent.

Thereby, the wafer chips 5′ and the support plate 1 can be released from each other using the handle jigs 13 as shown in S9 in FIG. 2.

In the above explanation, the release agent for melting the adhesive agent 3 from a peripheral portion of the adhesive agent 3 is supplied from the external environment to the porous portion receiving part (combined body supporting portion) surrounded by the peripheral wall 18 in the porous plate 10. However, the scope of the present invention is not limited to this example, and it goes without saying that the above suctioning process may be executed with the wafer chips shown in FIG. 3B being immersed in the release agent.

1. A method of releasing a support plate and wafer chips from each other, comprising:
dividing a wafer supported on a support plate using an adhesive agent into a plurality of wafer chips so that a groove is formed;
holding wafer chips via suction by a porous plate; and
guiding a release agent to the groove.

2. A method of releasing a support plate and wafer chips from each other, comprising:
dividing a wafer supported on a support plate using an adhesive agent into a plurality of wafer chips so that a groove is formed;
holding wafer chips via suction by a porous plate;
immersing the wafer chips in a release agent; and
guiding the release agent to the groove via the suction.

3. The method of releasing a support plate and wafer chips from each other according to claim 2, wherein:
when the release agent is guided, the release agent and the adhesive agent are made to contact each other, and the adhesive agent is melted.

4. The method of releasing a support plate and wafer chips from each other according to claim 2, wherein:
a wafer is divided for each device in the above dividing step.

5. The method of releasing a support plate and wafer chips from each other according to claim 2, wherein:
the suctioning is performed at a center of the porous plate.

6. The method of releasing a support plate and wafer chips from each other according to claim 1, wherein:
a plurality of areas are formed with boundaries forming concentric circles around a center in the porous plate, and the suctioning is performed for each area.

7. The method of releasing a support plate and wafer chips from each other according to claim 6, wherein:
the suctioning is started at different time points sequentially from a central area toward peripheral areas.

8. The method of releasing a support plate and wafer chips from each other according to claim 6, wherein:
the suctioning is performed in such a manner that suctioning power is decreased with increasing distance from a central area toward peripheral areas.

9. An apparatus for releasing a support plate and wafer chips from each other, comprising:
a porous plate for suctioning and holding singulated wafer chips supported on the support plate using an adhesive agent, and for suctioning a release agent.

10. An apparatus for releasing a support plate and wafer chips from each other according to claim 9, wherein:
a plurality of areas are formed with boundaries forming concentric circles about a central portion in the porous plate, and suctioning is performed from a central area sequentially to peripheral areas by a suction line connected to the central portion.

11. An apparatus for releasing a support plate and wafer chips from each other according to claim 9, wherein:
a plurality of areas are formed with boundaries forming concentric circles about a central portion in the porous plate, and suctioning is performed by a separate suction line for each area.

12. An apparatus for releasing a support plate and wafer chips from each other according to claim 10, wherein:
partitions are provided for the boundaries between the areas.

13. The method of releasing a support plate and wafer chips from each other according to claim 1, wherein:
when the release agent is guided, the release agent and the adhesive agent are made to contact each other, and the adhesive agent is melted.

14. The method of releasing a support plate and wafer chips from each other according to claim 1, wherein:
a wafer is divided for each device in the above dividing step.

15. The method of releasing a support plate and wafer chips from each other according to claim 1, wherein:
the suctioning is performed at a center of the porous plate.

16. An apparatus for releasing a support plate and wafer chips from each other according to claim 11, wherein:
partitions are provided for the boundaries between the areas.
